(19) United States
(12) Patent Application Publication
(10) Pub. No.: US 2005/0122675 A1
(43) Pub. Date: Jun. 9, 2005

(54) Framework configueuration of a computer host

(75) Inventor: Shih-Tien Cheng, Taipei (TW)

Correspondence Address: BRUCE H. TROXELL, SUITE 1404, 5205 LEESBURG PIKE, FALLS CHURCH, VA, 22041, US

(73) Assignee: Shuttle Inc.

(21) Appl. No.: 10/833,099

(22) Filed: Apr. 28, 2004

(30) Foreign Application Priority Data
Dec. 5, 2003 (TW) 092221447

(51) Int. Cl. G06F 1/16

(52) U.S. Cl. 361/685

(57) ABSTRACT

The present invention provides a framework configuration of a computer host, framework configuration of a computer host, which comprises: a mainframe, having a bottom plate on it's bottom portion; a motherboard, positioned above the bottom plate of the mainframe, having at least a CPU slot and a power input outlet thereon; a storage device holder, stacked over a space that is above the motherboard for positioning a storage device; and a cover, for covering over the mainframe.

### FIELD OF THE INVENTION

The present invention relates generally to a framework configuration of a computer host. More particularly, the present invention relates to a framework configuration of a computer host that has an external power supply installed outside a computer host for saving volume, and the CPU of the motherboard is positioned far from the user so as to flexibly configure the storage device of the computer.

### BACKGROUND OF THE INVENTION

Generally, the framework configuration of a computer host of the prior art, it's power supply is installed inside the housing of the computer host, and then the motherboard, Floppy Disk Drive, Hard Disk Drive and an Optical Drive are installed inside the housing respectively. However, the framework configuration of a computer host of the prior art cannot reduce the size of the housing, and the noise also cannot be reduced while the computer is running.

For example, Taiwan issued Patent No. 543501 “A FRAMEWORK OF A COMPUTER HOST” provides a framework of a computer host, which comprises: a small case, having at least one push exit opening and a plurality of opening; a motherboard, positioned inside the small case, for connecting a first connector of an Optical Drive; an interfacing Print Circuit Board (PCB), stacked above the motherboard, a Hard Disk Drive could be positioned on the rear side of the interfacing PCB, and an Optical Drive could be positioned on the front side of the interfacing PCB; a holder, positioned between the interfacing PCB and the Optical Drive, for connecting the Hard Disk Drive to the Optical Drive. The prior art uses an interfacing PCB that respectively has a Hard Disk Drive and the Optical Drive connector to save the wiring space of the computer housing. However, the interfacing PCB is consisted of a PCB and the circuit layout and size of the PCB is determined when it is designed. If changing the size of the computer housing, the appearance of the interfacing PCB may be could not match the requirement of the computer housing and it must be designed again. Thus the cost will be increased. Furthermore, if the interfacing PCB failed, the user must buy another interfacing PCB to replace, thus also increasing the user's loading.

Therefore, it needs a framework configuration of a computer host for the purpose of matching the requirement of light, thin, short and small of the mini computer.

### SUMMARY OF THE INVENTION

To solve the above problems, it is an object of the present invention to provide a framework configuration of a computer host, which has an external power supply installed outside a computer host for saving volume, and the CPU of the motherboard is positioned far from the user so as to flexibly configure the storage device of the computer.

To accomplish the above object of the present invention, there is provided a framework configuration of a computer host, which comprises: a mainframe, having a bottom plate on it's bottom portion; a motherboard, positioned above the bottom plate of the mainframe, having at least a CPU slot and a power input outlet thereon; a storage device holder, stacked over a space that is above the motherboard for positioning a storage device; and a cover, for covering over the mainframe.

The novel features of the invention are set forth with particularity in the appended claims. The invention will be best understood from the following description when read in conjunction with the accompanying drawings.

### BRIEF DESCRIPTION OF THE DRAWINGS

FIG. 1 shows an appearance of a framework configuration of a computer host in accordance with one embodiment of the present invention.

FIG. 2 shows a detail configuration of the moving holder 32 in accordance with one embodiment of the present invention.

FIG. 3 shows a diagram of disassembling the fixing holder 31 and the moving holder 32 in accordance with one embodiment of the present invention.

### DESCRIPTION OF THE PREFERRED EMBODIMENTS

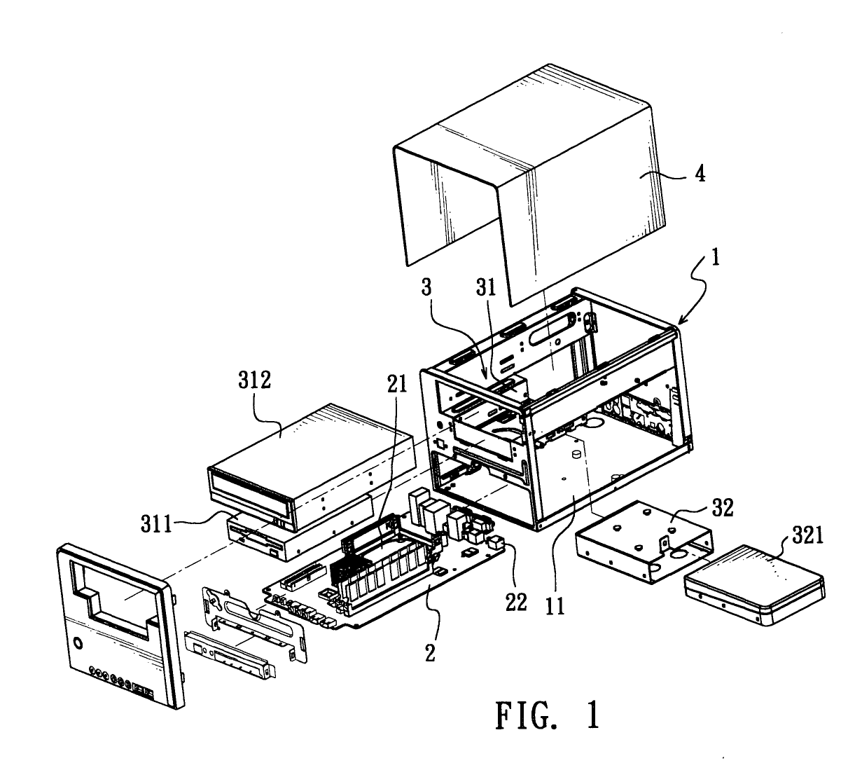

Referring to FIG. 1 shows an appearance of a framework configuration of a computer host in accordance with one embodiment of the present invention. As shown in FIG. 1, the framework configuration of a computer host comprises: a mainframe 1; a motherboard 2; a storage device holder 3 and a cover 4.

Wherein, the mainframe 1, having a bottom plate 11 on it's bottom portion; the motherboard 2, is positioned above the bottom plate 11 of the mainframe 1, having at least a CPU slot 21 and a power input outlet 22 thereon, wherein, the power input outlet 22 is for example but not limited to a 3×2 outlet, for providing a plug of an external power supply (not shown) plugged into. The CPU slot 21 is positioned behind the motherboard 1, namely, far from a user for the purpose of avoiding that the heat source (for example but not limited to a CPU, Hard Disk Drive or an Optical Drive) concentrates at the front half side of the motherboard 2 so as to flexibly configure the storage device of the computer, besides, the heat generated by the CPU can be exhausted outward directly by the fan (not shown) positioned behind the mainframe 1 so as to improve the heat dissipating efficiency.

The storage device holder 3, stacked over a space that is above the motherboard 2 for positioning a storage device, it further comprises a fixing holder 31 and a moving holder 32. Wherein, the fixing holder 31 is used to hold a Floppy Disk Drive 311 and an Optical Drive 312 and the Optical Drive 312 is stacked over the Floppy Disk Drive 311; the moving holder 312 is used to hold a first Hard Disk Drive 321. The cover 4 is used to cover over the mainframe 1, whereby, after the cover 4 covering over the mainframe 1, a plug of the external power supply (not shown) can be plugged into the power input outlet 22 for operating.

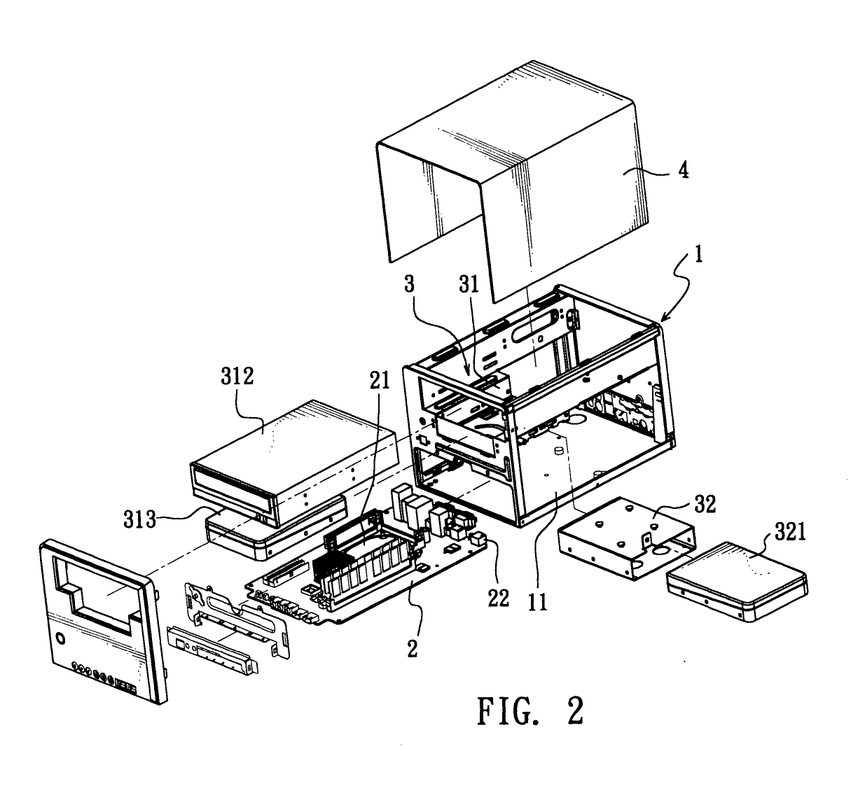

Referring to FIG. 2 shows a detail configuration of the moving holder 32 in accordance with one embodiment of the present invention. As shown in FIG. 2, the fixing holder 31 is used to hold a Floppy Disk Drive 311 and an Optical Drive 312, besides, the fixing holder 31 also can be positioned a second Hard Disk Drive 313 and an Optical Drive 312, and the Optical Drive 312 is stacked over the second Hard Disk Drive 313.

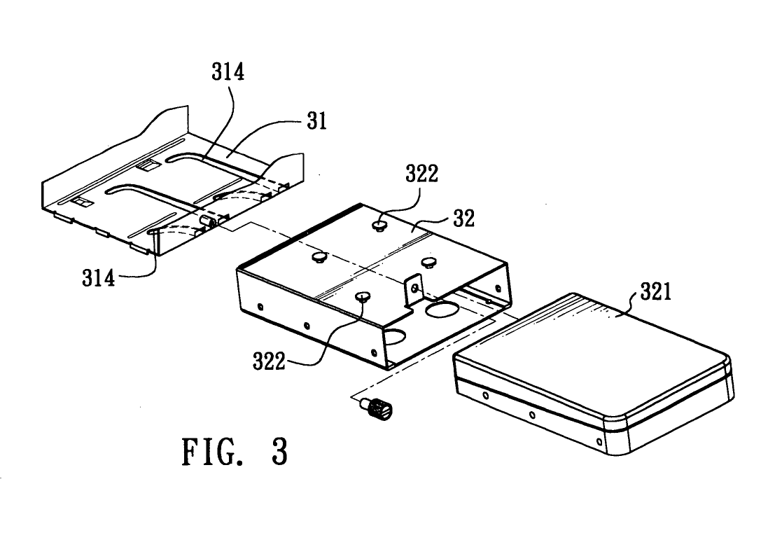

Referring to FIG. 3 shows a diagram of disassembling the fixing holder 31 and the moving holder 32 in accordance with one embodiment of the present invention. As shown in FIG. 3, the fixing holder 31 of the present invention further comprises at least one sliding slot 314, and has at lease one fastener 322 positioned at a place that is top of the moving holder 32 and opposition to the sliding slot 314 and can slide inside the sliding slot 314, whereby, the moving holder 32 can remove from the fixing holder 31 so as to conveniently assemble and disassemble the first Hard Disk Drive 321.

While the invention has been described with reference to a preferred embodiment thereof, it is to be understood that modifications or variations may be easily made without departing from the spirit of this invention, which is defined by the appended claims.

1. A framework configuration of a computer host, which comprises:
a mainframe, having a bottom plate on it's bottom portion;
a motherboard, positioned above said bottom plate of said mainframe, having at least a CPU slot and a power input outlet thereon;
a storage device holder, stacked over a space that is above said motherboard for positioning a storage device; and
a cover, for covering over said mainframe.

2. A framework configuration of a computer host as claimed in claim 1, wherein said CPU slot is positioned behind said motherboard, namely, far from a user.

3. A framework configuration of a computer host as claimed in claim 1, wherein said storage device holder further comprises a fixing holder and a moving holder.

4. A framework configuration of a computer host as claimed in claim 3, wherein said moving holder is used to hold a first Hard Disk Drive, and said fixing holder is used to hold a Floppy Disk Drive and an Optical Drive.

5. A framework configuration of a computer host as claimed in claim 4, wherein said Optical Drive is stacked over said Floppy Disk Drive.

6. A framework configuration of a computer host as claimed in claim 3, wherein said fixing holder is used to hold a second Hard Disk Drive and an Optical Drive.

7. A framework configuration of a computer host as claimed in claim 6, wherein said Optical Drive is stacked over said second Hard Disk Drive.

8. A framework configuration of a computer host as claimed in claim 3, wherein said fixing holder further comprises at least one sliding slot, and has at lease one fastener positioned at a place that is top of said moving holder and opposition to said sliding slot and can slide inside said sliding slot, whereby, said moving holder can remove from said fixing holder so as to conveniently assemble and disassemble said first Hard Disk Drive.

9. A framework configuration of a computer host as claimed in claim 1, wherein said power input outlet is a 3×2 outlet.

10. A framework configuration of a computer host, especially to a framework configuration of a computer host that has a external power supply installed outside a computer host for saving volume, which comprises:
a mainframe, having a bottom plate on it's bottom portion;
a motherboard, positioned above said bottom plate of said mainframe, having at least a CPU slot and a power input outlet thereon;
a storage device holder, stacked over a space that is above said motherboard for positioning a storage device; and
a cover, for covering over said mainframe;
whereby, after said cover covering over said mainframe, a plug of said external power supply can be plugged into said power input outlet for operating.

11. A framework configuration of a computer host as claimed in claim 10, wherein said CPU slot is positioned behind said motherboard, namely, far from a user.

12. A framework configuration of a computer host as claimed in claim 10, wherein said storage device holder further comprises a fixing holder and a moving holder.

13. A framework configuration of a computer host as claimed in claim 12, wherein said moving holder is used to hold a first Hard Disk Drive, and said fixing holder is used to hold a Floppy Disk Drive and an Optical Drive.

14. A framework configuration of a computer host as claimed in claim 13, wherein said Optical Drive is stacked over said Floppy Disk Drive.

15. A framework configuration of a computer host as claimed in claim 12, wherein said fixing holder is used to hold a second Hard Disk Drive and an Optical Drive.

16. A framework configuration of a computer host as claimed in claim 15, wherein said Optical Drive is stacked over said second Hard Disk Drive.

17. A framework configuration of a computer host as claimed in claim 12, wherein said fixing holder further comprises at least one sliding slot, and has at lease one fastener positioned at a place that is top of said moving holder and opposition to said sliding slot and can slide inside said sliding slot, whereby, said moving holder can remove from said fixing holder so as to conveniently assemble and disassemble said first Hard Disk Drive.

18. A framework configuration of a computer host as claimed in claim 10, wherein said power input outlet is a 3×2 outlet.
